(19) United States
(12) Patent Application Publication
(10) Pub. No.: US 2002/0156689 A1
(43) Pub. Date: Oct. 24, 2002

(54) System and method for securing transactions between buyer and credit authorizer

(75) Inventor: Jeff Spalding, Orlando, FL (US)

Correspondence Address: RICHARD K. WARTHER, Allen, Dyer, Doppelt, Milbrath & Gilchrist, P.A., P.O. Box 3791, Orlando, FL, 32802-3791, US

(73) Assignee: Far Soft, Inc., Orlando, FL (US)

(21) Appl. No.: 09/837,664

(22) Filed: Apr. 18, 2001

(51) Int. Cl. G06F 17/60

(52) U.S. Cl. 705/26

(57) ABSTRACT

A method and system allows a consumer to preauthorize charges to be billed using a consumer's credit or debit card and prevent approval of charges that have not been preauthorized. The merchant/seller can verify that the charges have been preauthorized and ensure that charges did not result from use of stolen credit or debit card numbers. The method and system is applicable to purchases made over the Internet and made by normal voice telephone calls to a merchant.

### FIELD OF THE INVENTION

This invention relates to a method and system for providing a secure transaction between a buyer and seller, and more particularly, this invention relates to a method and system for protecting a buyer from unauthorized charges when using a network, such as the Internet or telephone network, to purchase goods or services.

### BACKGROUND OF THE INVENTION

Ever since the introduction of the credit card as a method for purchasing goods and services, the possibility of fraudulent purchases being charged to the consumer has existed. The basic nature of the transaction is partly to blame. Specifically, the fact that the purchase consists of two or more transactions leads to potential difficulties. Also, the fact that purchases can often be completed with only a valid credit card number is a contributing factor.

At the time of the purchase, a transaction occurs between consumer and merchant, but no actual funds are exchanged. One or more additional transactions between the merchant and the payment provider must occur before payment is authorized. Additionally, other parties are often involved, such as a merchant's bank, one or more payment authorization networks and other third party providers.

Often, these transactions have been viewed as a sequential “chain of custody,” where the transaction details are passed from party to party, starting with the consumer, passing through the merchant and other parties, ultimately reaching the payment provider. The payment provider than makes the approval determination and returns this information through the chain of custody to the merchant.

The fact that multiple parties are involved in the chain of custody makes it difficult for the payment provider to verify that the transaction details have not been modified at any point along the chain of custody, and that the transaction was initiated by the consumer.

In looking specifically at fraud involving unauthorized credit card charges, several basic types of fraud are common. These can be classified as “security-based” fraud or “integrity-based” fraud.

In “security-based” fraud, the consumer's credit card number is acquired by an unauthorized third party. Traditionally, this has occurred in retail situations where the card is out of the consumer's sight for a period of time, or the card number has been printed on a receipt and left in an unsecured location. More recently, the advent of Internet purchasing has led instances of card numbers stored on merchant websites being “hacked” or otherwise compromised.

In “integrity-based” fraud, an authorized party uses the credit card number for purchases not initiated or approved by the consumer. This could be a retail merchant running multiple copies of a charge slip, an Internet merchant submitting a charge for a larger amount than approved by the consumer, or any merchant submitting multiple charges when only one was authorized.

The financial industry has dealt with fraud with using a variety of techniques. Most of these involve reactive measures, i.e., dealing with fraud after the fact. First, in order to protect the consumer, the payment providers generally release the consumer from responsibility for fraudulent charges above a nominal amount. This means that merchants and financial institutions bear the costs of fraud. Of course, these costs are indirectly passed to the consumer in the form of higher interest rates, higher prices and more fees.

More recently, in order to combat the increased awareness of credit card fraud in the Internet era, the financial industry is trying to implement technology solutions to improve security. First, the use of Secure Socket Layers (SSL) became a standard for merchant websites. While this lowers the chances of “security-based” fraud, it does nothing to protect against “integrity-based” fraud.

Initiatives to combat “integrity-based” fraud include the Secure Electronic Transactions (SET) protocol and other methods. SET is a protocol that encrypts the transaction data and passes the encrypted package from consumer to merchant and eventually to the payment provider. The package is not decrypted along the way, therefore the merchant and other parties never have access to the actual account number or other data. One of the big problems with SET and similar encryption methods is that every step along the entire chain of custody would require massive modifications to support it. With the number of merchants supporting the current credit authorization protocol, the implementation of SET seems highly unlikely, at least in the near future.

A new solution that does not require changes to the current authorization protocol or the transaction “chain of custody” would be preferable. In addition, it would be advantageous if this solution would negate the value of a stolen credit card number. Further, the ideal solution would involve a direct link between the consumer and the payment provider to authenticate the validity of each purchase.

### SUMMARY OF THE INVENTION

It is therefore an object of the present invention to provide a system and method for providing a secure transaction between a buyer and seller.

It is yet another object of the present invention to provide a system and method for preventing unauthorized use of a credit/debit card during a transaction between a buyer and seller, such as a consumer and merchant using the Internet. The present invention is advantageous and provides a system and method for preventing unauthorized use of a credit card or debit card by allowing the establishment of a direct link between a buyer, such as a consumer using the Internet, and an authorization processor, such as a credit or debit card provider. The consumer informs the authorization processor of each and every purchase approved by the buyer prior to completion of the purchase. The authorization processor can use an accepted method of authenticating the identity of the buyer to ensure the integrity of the communication link. This authentication could be by data encryption, PIN verification or other accepted practices. A merchant (seller) also can determine, prior to delivery of goods or services, that a given purchase has been initiated by a consumer (buyer), who is using a preauthorization process and, therefore, the purchase does not involve use of stolen or otherwise unauthorized debit or credit card numbers. This is significant because a merchant often suffers financial losses due to stolen card numbers.

Throughout this description, a preauthorization is generated by the buyer and sent to the authorization processor. An approval code is generated by the authorization processor and supplied to both the buyer and seller. An authorization request is generated by the seller and sent to the authorization processor.

In the steps and sequence of the present invention, a buyer preauthorizes a purchase by notifying the authorization processor of the intent to purchase and the amount of purchase. The authorization processor approves the purchase, based on the available credit or debit account balance and the card account status and generates an approval code. The authorization processor provides the approval code to the buyer. The buyer pre-supplies the approval code to the seller and, upon receiving the eventual real authorization request from the seller, the authorization processor will provide the same approval code to the seller that was previously provided to the buyer. This authorization request from the seller could occur only seconds after the authorization processor provides the approval code to the buyer or some days later.

In one aspect of the invention, the authorization processor comprises one of at least a credit or debit card provider. The seller comprises a merchant. The approval codes and preauthorizations can be transmitted and received via a computer network. The identity of the buyer can be authenticated by the authorization processor before approving the transaction between the buyer and seller.

In another aspect of the invention, the transaction between buyer and seller is one for the purchase of goods and/or services. The preauthorization can be made to the authorization processor from the buyer via a voice call from the buyer. The authorization processor can also include an interactive voice response unit for receiving and handling the voice call from the buyer.

### BRIEF DESCRIPTION OF THE DRAWINGS

Other objects, features and advantages of the present invention will become apparent from the detailed description of the invention which follows, when considered in light of the accompanying drawings in which:

FIG. 1 is a diagram showing the relationship between the major parties involved in a credit card purchase over the Internet, including the consumer, the merchant, the authorization network and the authorization processor.

FIG. 2 illustrates the visual placement and relationship of the web browser and the PC pre-authorization program icon.

FIGS. 3A and 3B are flow charts showing the steps involved for a consumer to order goods or services using a web browser while connected to the Internet and using the preauthorization process.

FIG. 4 is a flow chart showing the steps performed by the authorization processor when the consumer requests a preauthorization.

FIG. 5 is a flow chart showing the steps taken by the merchant to authorize a purchase.

FIG. 6 is a flow chart showing the steps performed by the authorization processor when a merchant submits an authorization request.

FIG. 7 is a diagram showing the relationship between the major parties involved in a credit card purchase by telephone, including the consumer, the merchant, the authorization network and the authorization processor.

FIG. 8 is a flow chart showing the steps involved for a consumer to order goods or services by telephone using the preauthorization process.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention is advantageous and provides a system and method that allows a consumer to preauthorize charges to be billed using a consumer's credit or debit card, while preventing approval of charges that have not been preauthorized. Merchants can verify that charges have been preauthorized, and thus, ensure that charges do not result from the use of stolen credit or debit card numbers. This system and method is applicable to a purchase made not only over a computer network, such as the publicly accessible Internet, but also made by purchases using normal voice telephone calls to a merchant.

Throughout this description, various terms are used as follows:

“Preauthorization,” “preauthorization request”—These two interchangeable terms refer to the request/prenotification made by the consumer/buyer to the authorization processor that the consumer/buyer wishes to approve or authorize a particular purchase.

“Authorization processor”—This refers to the institution or agency that approves or disapproves purchases against the consumer's line of credit or debit account, as appropriate. It acts as an agent of the consumer.

“Buyer,” “consumer”—These two interchangeable terms refer to the person or business entity wishing to purchase goods and/or services from a merchant.

“Seller,” “merchant”—These two interchangeable terms refer to the supplier of the goods or services.

“Approval code,” authorization code”—These two interchangeable terms refer to the code generated by the authorization processor which indicates that the consumer has sufficient funds or credit and that a purchase request has been (or will be) approved for the amount requested. This approval code can be supplied both to the consumer and the merchant.

“Authorization request”—This term refers to the request made by the merchant to the authorization processor to receive payment for goods and/or services supplied to or on behalf of the consumer.

“Merchant ID”—This term refers to the unique identification used within the purchase authorization network to identify an individual merchant. This merchant ID may be passed from merchant to consumer, from consumer to authorization processor and from merchant to authorization processor.

“Account ID,” account number”—These two interchangeable terms refer to the unique identification used within the purchase authorization network to identify a specific consumer credit or debit card.

“Purchase authorization network”—The financial network, consisting of various telecommunications links and protocols, used to provide the framework for credit and debit card processing. Examples of this include: VISA®, MASTERCARD® and AMERICAN EXPRESS®.

“Secure-link program”—This term is used to identify the computer program running on the consumer's desktop personal computer which connects to the authorization processor and provides the pathway for transmitting preauthorizations from the consumer to the authorization processor.

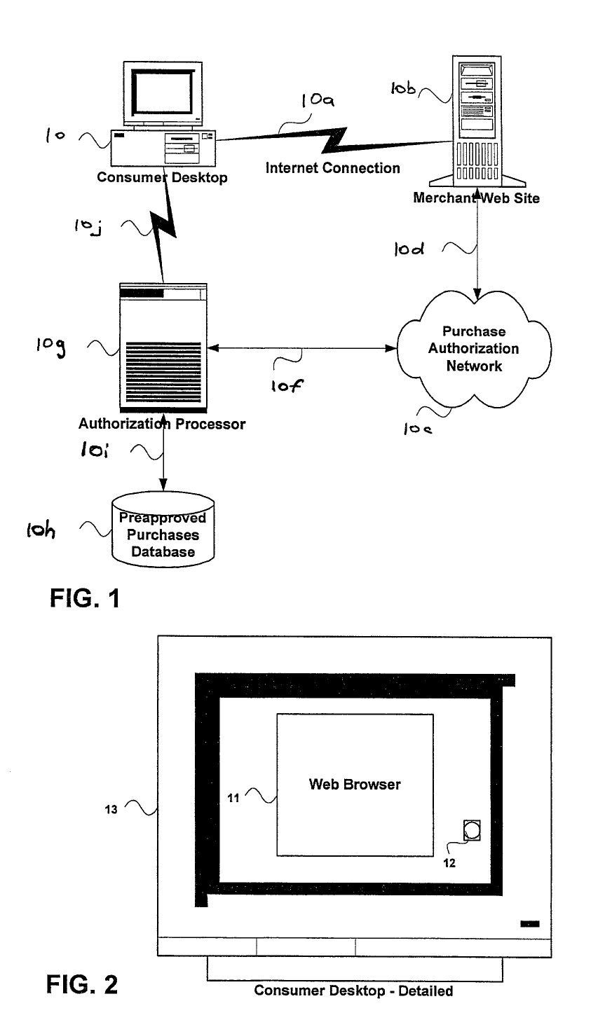

FIG. 1 illustrates a system of the present invention showing a consumer (buyer) desktop computer 10 that has Internet connection 10a to a merchant (seller) website having a merchant server 10b. The seller and buyer can be respective consumer and merchant, although many other types of transactions are possible with the present invention. The merchant website is operatively connected to a purchase authorization network 10c via communication link 10d, which could be the publicly accessible Internet or other financial or other authorization network link known to those skilled in the art. The purchase authorization network connects via the communication link 10f to an authorization processor 10g, which could be a computer or other server located at a credit card or debit card provider. The authorization processor is operative with a preapproved purchases database 10h and connected via link 10i, which could be an internal computer link or external communication link. Authorization processor 10g connects to consumer desktop 10 via communication 10j.

FIG. 2 shows an illustrated consumer desktop computer 10 having a computer monitor screen 13 with a web browser 11 and a preauthorization program icon 12 that allows the user to select “secure-link” software for using the system and method of the present invention. Such software routines can be programmed and established by techniques known to those skilled in the art.

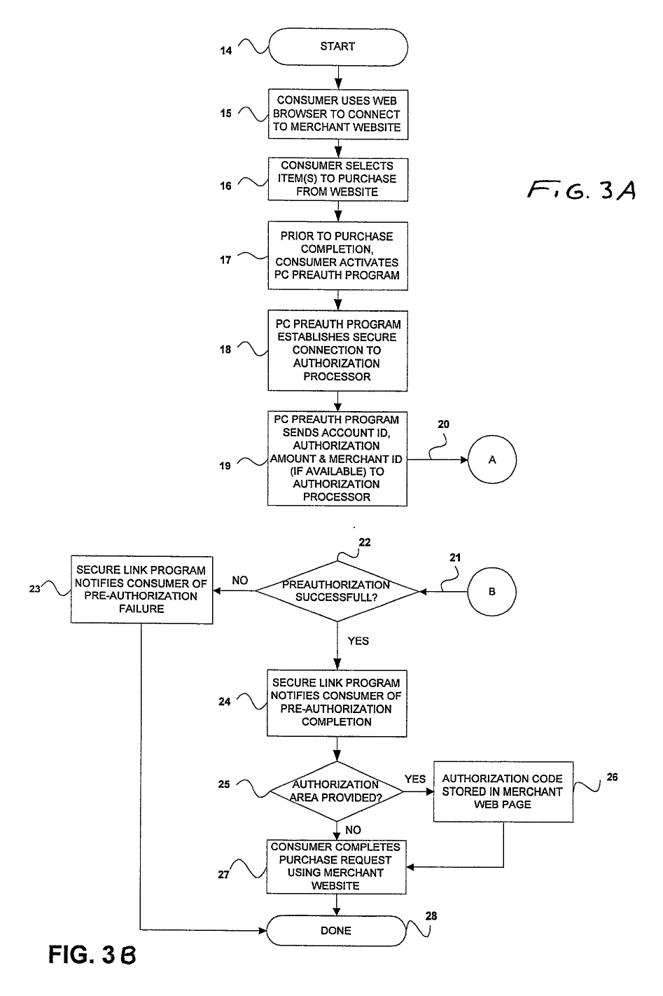

FIGS. 3-6 show flow charts for the steps involved and used by the buyer, seller and authorization processor when goods or services are ordered using a web browser while connected to the Internet. The software “secure-link” routine begins in FIG. 3A (block 14) showing the start of the process. The software allows a secure purchase, but the invention is not limited to a web browser and internet purchases. It could include any transaction that required enhanced purchase security. For example, if a seller were to approach an agent of the buyer, i.e., the authorization processor, for payment and the buyer or other consumer is not present at that point, normally, the agent or authorization processor would not know for certain that the “alleged” buyer actually authorized the payment. With the present invention, it is possible to provide for this capability without disrupting the normal established method of payment approval and can work well in similar situations.

In one aspect of the present invention, the authorization processor could be part of the debit or credit card holding company, as noted above. In yet another aspect of the present invention, the authorization processor acts as agent on behalf of the lending institution, such as the credit card or other financial institution, such as a debit card institution. For example, an automatic teller machine network authorizes debit and/or credit card purchases for the client banks. In this instance, the ATM network acts in capacity somewhat as an agent for the bank when it approves an authorization request.

A consumer or buyer uses a web browser to connect to a merchant website (block 15). A consumer selects the item(s) to purchase from the website (block 16). Prior to purchase completion, the consumer activates a personal computer preauthorization program routine (block 17), such as double clicking on the “secure-link” program icon shown at 12 on the monitor 13 of the consumer or buyer desktop computer. The personal computer “secure-link” program automatically sends an account identification, an authorization amount and a merchant identification (if available) to the authorization processor as a preauthorization, or preauthorization request.

At this time, the buyer has selected the items to purchase, but no transaction or contract has been completed between the buyer and seller, i.e., a consumer and merchant.

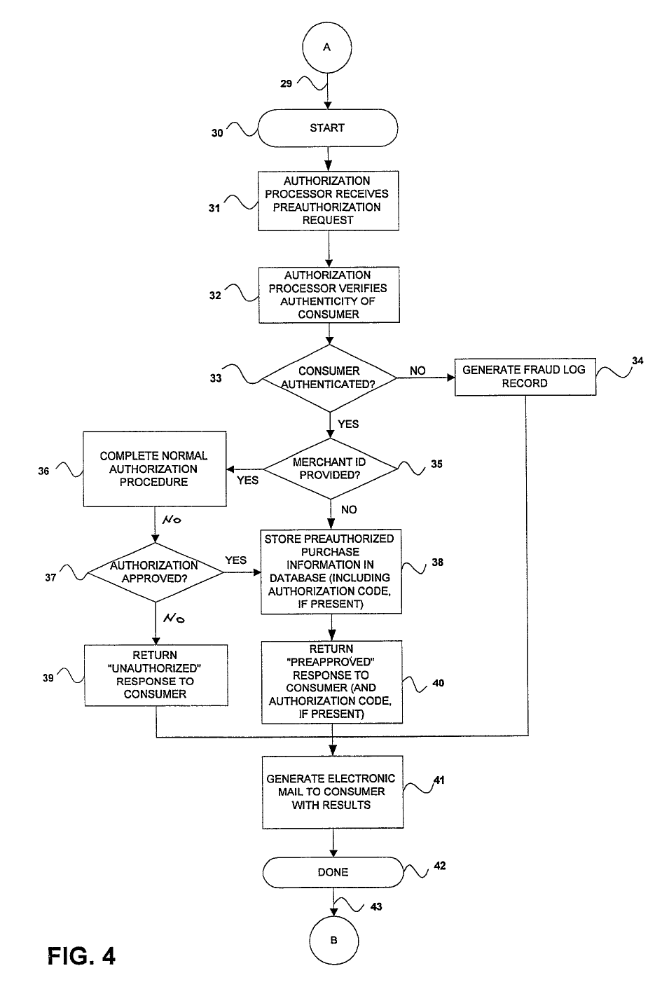

The process continues as shown in FIG. 4 where the preauthorization request is sent via the computer network, such as the Internet, to the authorization processor, which then begins its software routine (block 30). The authorization processor receives the preauthorization request (block 31). The authorization processor verifies the authenticity of the consumer (block 32). Any accepted method of authenticating the identify of the consumer can be used, including various types of data encryption, PIN verification and other accepted practices. Naturally, the present invention does not restrict or determine the method of authentication, but in many instances, only requires its implementation.

The authorization processor determines if the consumer is authenticated (block 33). If not, then the authentication processor generates a fraud log record for future purposes and law enforcement details (block 34). An electronic mail can be generated to the credit card or debit card holder, i.e., the proper buyer, showing the results, such as the generated fraud log record (block 41).

If the consumer has been authenticated, the authorization processor determines if a merchant ID is provided (block 35). If the merchant ID is provided, then the normal authorization procedure is completed (block 36), and a determination is made whether authorization is approved (block 37). If no authorization is approved, then an “unauthorized” return response is generated to the consumer (block 39). After the “unauthorized” response is returned to the consumer, the record is generated for the fraud log (block 34). If the merchant ID is not provided, or the merchant ID was provided and the authorization was approved, then the preauthorized purchase information is stored in a database, including the returned authorization code, if approved (block 38). A “preapproved” response is returned to the consumer and the authorization code, if it is present (block 40). An electronic mail can be generated to the consumer with the results (block 41), which could include the preapproval response, but not the approval code. The authorization process is done (block 42) and the consumer, i.e., buyer, then begins the next software routine.

As shown in FIG. 3B, if the preauthorization is successful (block 22), then the secure link program notifies the consumer of the preauthorization completion (block 24). A determination is made if the authorization area is provided by the merchant web page (block 25). If yes, then the authorization code is stored in the merchant web page (block 26). The consumer then completes the purchase request using the merchant website (block 27). If an authorization area is not provided, then the consumer still completes the purchase request using a merchant website (block 27). If the preauthorization has not been successful, then the secure link program notifies the consumer of the preauthorization failure (block 23). The consumer link program is then completed (block 28).

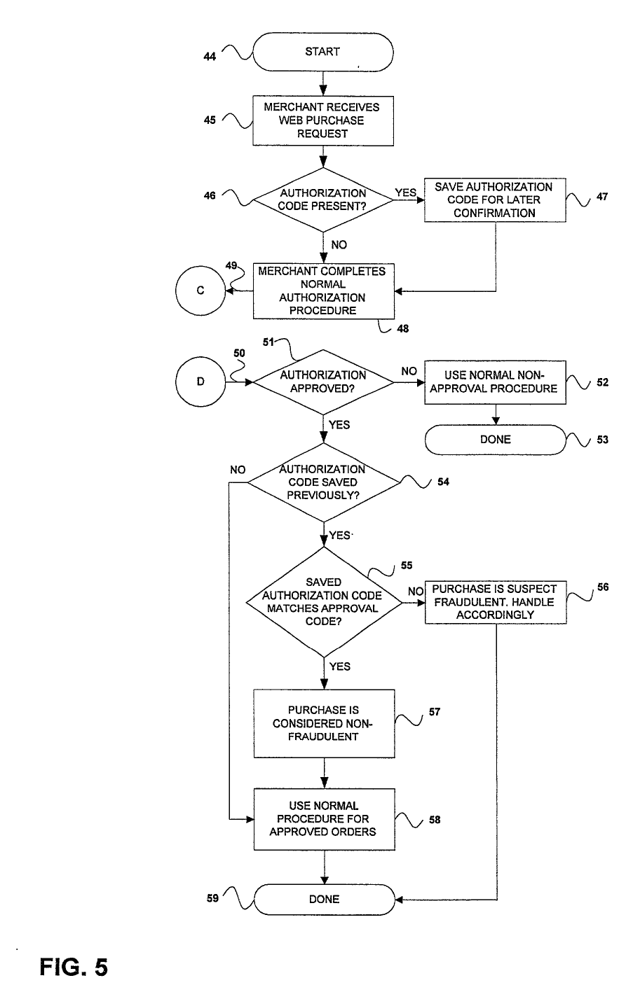

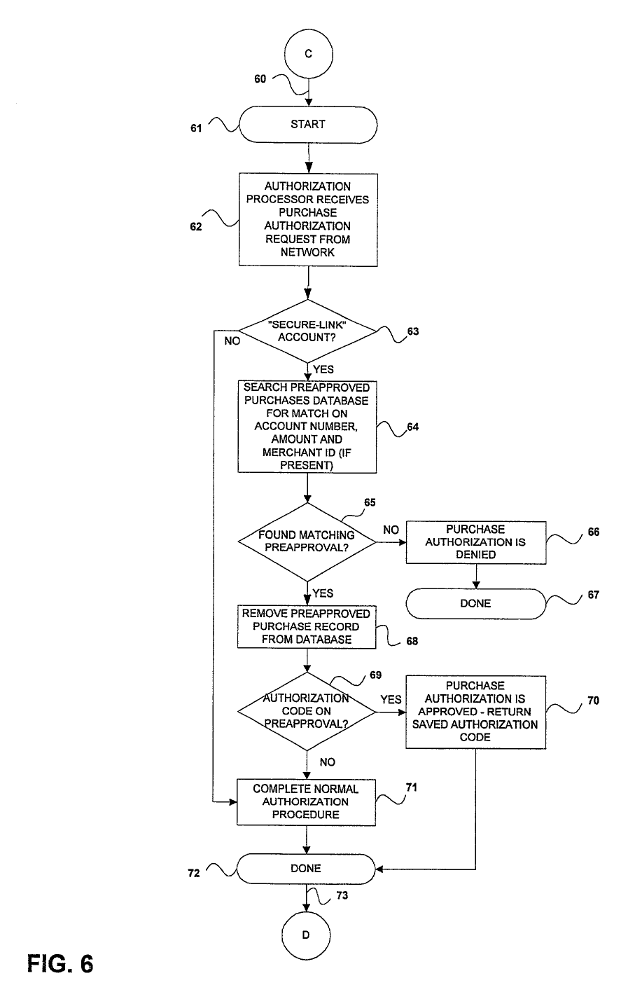

FIG. 5 illustrates a flow chart showing the steps taken by the merchant to authorize a purchase once in connection with the buyer. The routine starts (block 44) when the merchant receives a web purchase request (block 45), such as from the buyer. The server then determines whether the authorization code is present (block 46), and if it is not, then the merchant completes the normal authorization procedure (block 48). If the authorization code is present, then the merchant server saves the authorization code for later confirmation (block 47). The merchant then forwards information to the authorization processor, which then begins its routine as shown in FIG. 6 (block 61).

The authorization processor receives the purchase authorization request from the Internet and merchant (block 62). It first determines whether this authorization request is being made using a “secure-link” account (block 63), i.e., using the secure system and method of the present invention. If not, the normal authorization procedure is completed (block 71). If this is an authorization request for a “secure-link” account, then the authorization processor searches the preapproved purchases database for a match on the account number, the amount and the merchant ID (if present) (block 64). The authorization processor then determines if a match is found for preapproval (block 65), and if not, then the purchase authorization is denied (block 66) and the routine is done (block 67). If a match is found, then the preapproved purchase record is removed from the database (block 68).

The authorization processor determines if the preapproved purchase record contains an authorization code (block 69), and if yes, the purchase authorization is approved and the previously saved authorization code is transmitted to the merchant (block 70). If there is no preapproval, then the normal authorization procedure is completed (block 71). The system is done (block 72). The merchant or seller then checks to see if an authorization code was transmitted by the authorization processor, signifying an approval (block 51). If not, then the normal nonapproval procedure used by the merchant or seller is accomplished (block 52) and the system done (block 53). If the authorization has been approved, then the merchant determines if the authorization code has been saved previously (block 54). If not, then the normal procedure for approved orders is accomplished (block 58). If the authorization code has been saved previously, then a determination is made by the merchant whether the saved authorization code matches the approval code (block 55). If not, then the purchase is suspect as fraudulent and is handled according to standard procedures by the merchant (block 56). If the purchase is considered non-fraudulent (block 57), then normal procedures are used for approving orders (block 58).

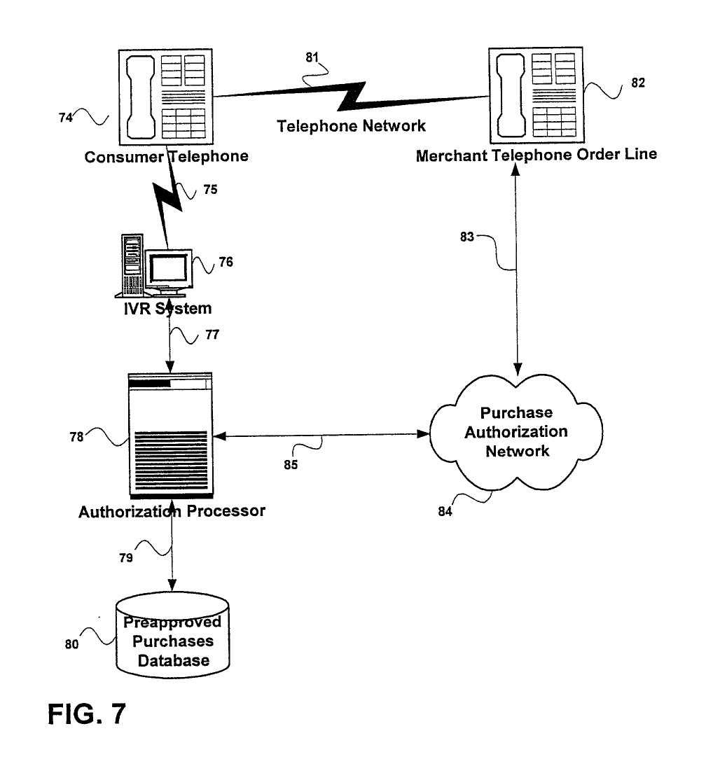

FIG. 7 illustrates a diagram showing the relationship between major parties involved in a credit card purchase by telephone, including the consumer, merchant and authorization network and authorization processor. Instead of a consumer desktop, a buyer or consumer uses the consumer telephone 74 and transmits a voice call over the communications network 81 to a merchant telephone order line 82. The authorization processor 78 works with the purchase authorization network and merchant telephone order line 82 and an IVR system 76. Naturally, the consumer telephone line could be connected via Internet or the public switched telephone network, but transmits the signals via line 75 to the IVR system 76, which is operative via line 77 to the authorization processor. The preapproved purchases database 80 is operable with communication link 79 and the authorization processor.

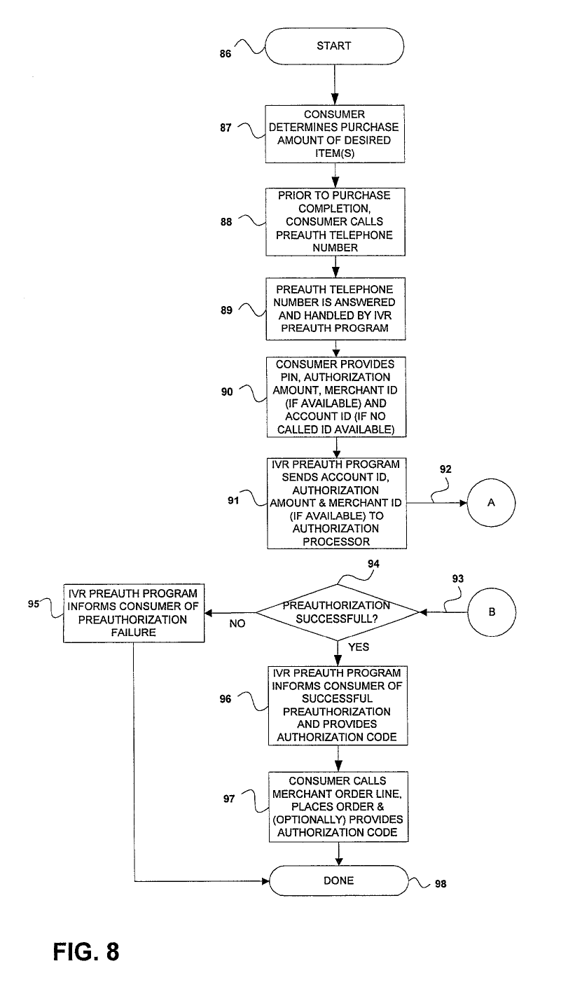

FIG. 8 illustrates a flow chart showing the steps involved for a consumer to order goods or services by telephone using the preauthorization process. Many of the steps are similar to what has been described before and the unique steps for this aspect of the invention are illustrated.

The process begins (block 86) and the consumer determines the purchase amount of the desired item(s) (block 87). Prior to the purchase completion, the consumer calls the preauthorization telephone number (block 88). This preauthorized telephone number is answered and handled by an interactive voice response unit of the issuing credit or debit card or similar system and handled by an IVR preauthorization program (block 89). The consumer can provide a PIN (for security purposes), authorization amount, merchant ID (if available), and an account ID (block 90). If automatic number identification (ANI) is available, then it is used to identify the consumer, and thus, the account ID need not be supplied by the consumer. The IVR preauthorization program sends the account ID, authorization amount and merchant ID (if available) to the authorization processor (block 91). The system then continues as shown in FIG. 4.

If a preauthorization is successful (block 94), then the IVR preauthorization program informs the consumer of the successful preauthorization and provides an authorization code (block 96). The consumer calls the merchant order line and places the order and optionally can provide an authorization code (block 97). The system is then done (block 98). If a preauthorization is not successful, then the IVR preauthorization program can inform the consumer of the preauthorization failure (block 95).

It is evident that the present invention is advantageous and prevents unauthorized use of a credit or debit card by using a direct link program between the consumer and authorization processor. The consumer can inform the authorization processor of each and every purchase approved by the consumer prior to the completion of the purchase. The identity of a consumer can be authenticated to ensure integrity of a link between the consumer and authorization processor. The merchant can also use the preauthorization processor to reduce any financial losses due to stolen card numbers because the merchant now can determine if a stolen or otherwise unauthorized credit card number is used, provided that the credit card number in question was being authorized using the present invention.

Another possible use of this invention is to determine, based on the presence or non-presence of a magnetic stripe at the time of authorization, whether the purchase represents a “card-not-present” transaction. If the magnetic stripe is not present, it means the card was not swiped successfully. Usually this indicates a “card-not-present” transaction. However, this can also occur in “card-present” situations if the magnetic stripe is damaged or the card swipe machine is defective. If this is a “card-not-present” transaction, the invention would be authorized to block any purchases which were not consumer preapproved. However, if the magnetic stripe is present at the time of authorization, this is indication of a “card-present” transaction and the invention would not be utilized for these purchases. Normally, internet and telephone purchases are “card-not-present” transactions. This actually means that the card was not physically presented to the merchant.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A method for providing a secure transaction between a buyer and seller comprising the steps of:
sending to a seller from the buyer an approval code;
matching the approval code received from the buyer with an approval code received from an authorization processor; and
confirming the transaction between buyer and seller if a match is made between the approval codes.

2. A method according to claim 1, wherein said authorization processor comprises one of at least a credit or debit card provider.

3. A method according to claim 1, wherein said seller comprises a merchant.

4. A method according to claim 1, wherein said approval codes are transmitted and received via a computer network.

5. A method according to claim 1, and further comprising the step of authenticating the identity of the buyer by the authorization processor before approving the transaction between the buyer and seller.

6. A method according to claim 1, wherein the transaction between buyer and seller is one for the purchase of goods and/or services.

7. A method according to claim 1, wherein a preauthorization is made to the authorization processor from the buyer via a voice call from the buyer.

8. A method according to claim 1, wherein said authorization processor comprises an interactive voice response unit for receiving and handling the voice call from the buyer.

9. A method according to claim 1, wherein the preauthorization comprises an approval code.

10. A method according to claim 9, wherein said preauthorization further comprises a credit card number.

11. A method for providing a secure transaction between a buyer and seller comprising the steps of:
receiving at a seller a transaction request from a buyer while also providing the seller an authorization code;
requesting by the seller an approval for the transaction request from an authorization processor;
returning to the seller an authorization code; and
approving the transaction request if the authorization codes match.

12. A method according to claim 11, and further comprising the step of providing normal credit card information to the seller from the buyer together with the authorization code.

13. A method according to claim 11, and further requesting by the buyer an authorization code from the authorization processor to forward to the seller.

14. A method according to claim 11, wherein said authorization processor further comprises one of at least a credit or debit card provider.

15. A method according to claim 11, wherein said seller comprises a merchant.

16. A method according to claim 11, wherein request for an authorization code is made to the authorization processor from the buyer via a voice call from the buyer.

17. A method according to claim 16, wherein the authorization processor comprises an interactive voice response unit for receiving and handling the voice call from the buyer.
